(19) United States
(12) Patent Application Publication
(10) Pub. No.: US 2026/0331640 A1
(43) Pub. Date: Oct. 22, 2026

(54) BATTERY MODULE, BATTERY PACK AND ELECTRIC VEHICLE INCLUDING THE SAME

(71) Applicant: SAMSUNG SDI CO., LTD., Yongin-si (KR)

(72) Inventors: Stefan HASENAUER, Graz (AT); Helmut RATH, St. Veit (AT); Johannes GRASPEUNTNER, Graz (AT); Matej PRANJIC, Feldkirchen bei Graz (AT); Juan Manuel GUTIERREZ DUARTE, Graz (AT)

(21) Appl. No.: 19/427,654

(22) Filed: Dec. 19, 2025

(30) Foreign Application Priority Data
Apr. 16, 2025 (EP) 25170992.9

(51) Int. Cl. H01M 10/6568; H01M 10/613; H01M 10/6556; H01M 50/249; H01M 50/291

(52) U.S. Cl. CPC H01M 10/6568; H01M 10/613; H01M 10/6556; H01M 50/249; H01M 50/291; H01M 2220/20

(57) ABSTRACT

A battery module includes: a stack including a plurality of battery cells and spacers arranged between adjacent ones of the battery cells; and a battery module housing accommodating the stack and including a bottom, a first side wall, and an opposing second side wall. The battery module housing is configured to hold a liquid coolant to immerse the stack in the liquid coolant, and the spacers are configured to allow the liquid coolant to pass from one side of the stack to another side of the stack. The first side wall includes a first bulge having a first flow passage for the liquid coolant, extends along the entire length of the first side wall, and has a coolant inlet at one end thereof, and the second side wall has a second bulge having a second flow passage for the liquid coolant, extends along the entire length of the second side wall, and has a coolant outlet at one end thereof.

### CROSS-REFERENCE TO RELATED APPLICATION

The present application claims priority to and the benefit of European Patent Application No. 25170992.9, filed on Apr. 16, 2025, in the European Patent Office, the entire disclosure of which is incorporated herein by reference.

### BACKGROUND

### 1. Field

Aspects of embodiments of the present disclosure relate to a battery module, a battery pack including a plurality of the battery modules, and an electric vehicle including the battery module and/or the battery pack.

### 2. Description of the Related Art

A battery module is formed of (or includes) a plurality of battery cells connected together in series and/or in parallel. The battery module is formed by interconnecting electrode terminals of the plurality of battery cells, with the number and connection configuration of the battery cells depending on a desired amount of power, to realize a relatively high-power rechargeable battery.

Battery modules can be constructed in either a block design or a modular design. In the block design, each battery cell is coupled to a common current collector structure and a common cell management unit and is accommodated in a housing. In the modular design, pluralities of battery cells are connected together to form submodules, and several submodules are connected together to form the battery module. In automotive applications, battery systems often include a plurality of battery modules connected together in series to provide a desired voltage.

A battery pack is a set of any number of (usually identical) battery modules and/or single battery cells. The battery modules or, respectively, the battery cells, may be connected in a series, parallel, or series/parallel configuration to provide the desired voltage, capacity, and/or power density. Components of a battery pack include the individual battery modules and interconnects, which provide electrical conductivity between the battery modules.

An active or passive thermal management system may be included to provide thermal control of the battery pack to safely use the battery module(s) by efficiently emitting, discharging, and/or dissipating heat generated from its rechargeable batteries. If the heat emission/discharge/dissipation is insufficiently performed, temperature deviations may occur between respective battery cells, such that the battery module(s) may no longer generate a desired (or designed) amount of power. In addition, an increase in the internal temperature of the rechargeable battery can lead to abnormal reactions occurring therein, and thus, charging and discharging performance of the rechargeable battery deteriorates and the life-span of the rechargeable battery is shortened. Thus, cell cooling by effectively emitting/discharging/dissipating heat from the battery cells is desired.

The effective management of thermal energy is important for the optimal functioning and longevity of rechargeable batteries in mobile applications. The ability to regulate temperature can allow full performance and operational readiness in a wide range of conditions. Thermal management encompasses both cooling and heating operations. Given the considerable diversity of rechargeable battery variants, characterized by differences in cell chemistry and structure, the thermal management should be tailored to the specific requirements of each variant. A similar situation pertains to the numerous different vehicle applications, which encompass a range of vehicles from small city cars to sports cars, as well as vehicles with mild hybridization and purely electric vehicles. Furthermore, integration into the vehicle's thermal circuits is becoming more important.

In the case of air cooling, cooling air flows around the battery cell, thereby cooling the accessible (or exposed) surfaces. Because this type of cooling does not necessitate direct thermal contact with the battery cell, the interface to the cooling system is relatively straightforward. Nevertheless, the installation space required for the cooling air ducts between the battery cells is considerable, and the cooling effectiveness, in particular, the homogeneity of cell cooling, is often inadequate. In contrast, cooling methods that establish thermal contact with the battery cell and dissipate the heat via heat conduction are demonstrably more effective than air cooling in terms of cooling efficacy. Nevertheless, the design of the thermal contact presents a new set of challenges. The interface to the cooling system is more complex, as the cooling apparatus is in direct contact with the electrical components of the battery cell. In the case of cells having a relatively low height (e.g., short cells) and sufficiently thick cell walls, it may be sufficient to simply make contact with a bottom of the battery cell via a cooling plate. Should this prove inadequate, supplementary heat conduction elements must be incorporated between the battery cells to facilitate the transfer of heat to the cooling plate. However, this results in a heavier and more expensive cooling system.

The use of fluid-conducting cooling plates between the battery cells has been demonstrated to be an effective cooling method, as the heat conduction path from the interior of the battery cell to the cooling fluid is relatively short, resulting in a high degree of temperature homogeneity within the battery cell. An alternative approach to cooling is arrester cooling. In this method, the interior of the battery cell is cooled directly via electrodes of the battery cell. For example, pouch-type battery cells are well-suited for this type of cooling, as they have flat, and therefore relatively easy-to-contact, terminals. The waste (or excess) heat from the battery cells is directed to a cooling plate. There, either cooling water or an evaporating refrigerant absorbs the heat and dissipates it to the environment via the vehicle's cooling or refrigeration system.

Another method of cooling the battery cells is immersion cooling, where the cells are fully immersed in a cooling agent flowing around the cell housings. Immersion cooling enables excellent cooling performance. By using a sealed cover-tub, where the cells are only partially immersed in the cooling agent, the risk of short circuits is also reduced or minimized.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a battery module includes a stack including a plurality of battery cells and spacers arranged between adjacent ones of the battery cells and a battery module housing accommodating the stack. The battery module housing including a bottom, a first side wall, and an opposing second side wall. The battery module housing being configured to hold a liquid coolant such that the stack is immersed in the liquid coolant, and the spacers are configured to allow the liquid coolant to pass through from one side of the stack to another side of the stack. The first side wall includes a first bulge having a first flow passage, extending along the entire length of the first side wall, and having a coolant inlet at one end thereof. The second side wall includes a second bulge having a second flow passage, extending along the entire length of the second side wall, and having a coolant outlet at one end thereof.

According to another embodiment, a battery pack includes a side-by-side arrangement of a plurality of the battery modules. The battery modules are arranged such that the first side walls and the second side walls are adjacent to one another.

According to another embodiment, an electric vehicle includes the aforementioned battery module or the aforementioned battery pack.

Further embodiments, aspects, and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a perspective view of a battery module according to an embodiment.

FIG. 2 is an exploded view of the battery module shown in FIG. 1.

FIG. 3 is a partial cross-sectional view of a side-by-side arrangement of three battery modules and coolant flow through a spacer of the battery module according to an embodiment.

FIG. 4 is a top view of the battery module shown in FIG. 1 without a cover tub and illustrates coolant flow within a battery module housing.

FIG. 5 is a partial cross-sectional view of the battery module shown in FIG. 1 and a coolant flow within a part of the battery module housing.

FIG. 6 illustrates an electric vehicle including a battery pack according to another embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

In the figures, dimensions of the various elements, layers, etc. may be exaggerated for clarity of illustration. The same reference numerals designate the same elements. As used herein, the term “and/or” includes any and all combinations of one or more of the associated listed items. Expressions such as “at least one of”, when preceding a list of elements, modify the entire list of elements and do not modify the individual elements of the list. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

The electronic or electric devices and/or any other relevant devices or components according to embodiments of the present disclosure described herein may be implemented utilizing any suitable hardware, firmware (for example an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example on a PCB or another kind of circuit carrier. The conducting elements may include metallization, for example surface metallizations and/or pins, and/or may include conductive polymers or ceramics. Further electrical energy might be transmitted via wireless connections, for example using electromagnetic radiation and/or light.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification and should not be interpreted in an idealized or overly formal sense, unless expressly so defined herein.

According to an embodiment of the present disclosure, a battery module includes a stack of a plurality of battery cells with spacers arranged between adjacent ones of the battery cells and a battery module housing accommodating the stack. The battery module housing includes a bottom, a first side wall, and an opposing second side wall and is configured to hold a liquid coolant such that the stack is immersed in the liquid coolant. The spacers are configured to allow the liquid coolant to pass therethrough from one side of the stack to the other. The first side wall has a first bulge having a first flow passage and extending over (or along) the entire length of the first side wall, and the second side wall has a second bulge having a second flow passage and extending over (or along) the entire length of the second side wall. A coolant inlet is provided at one end of the first bulge, and a coolant outlet is provided at one end of the second bulge.

One aspect of the present disclosure relates to a battery module. A battery module may be understood as a structural unit including interconnected battery cells for storing and supplying electrical energy, typically housed within a casing designed to provide mechanical support, thermal management, and protection against environmental factors.

The battery module includes a stack of a plurality of battery cells with spacers arranged between adjacent ones of the battery cells. A stack refers to a sequential arrangement of battery cells positioned in close proximity to form a cohesive assembly, while spacers are interstitial components designed to maintain a spacing or spacing range (e.g., a predetermined spacing or spacing range between adjacent battery cells. This arrangement enables controlled physical separation between the battery cells, ensuring mechanical stability, enhancing thermal dissipation, and facilitating fluid flow for cooling. This arrangement allows for effective management of heat generated during operation, which helps to extend battery life and enhance performance.

The battery module includes a battery module housing accommodating the stack. The battery module housing includes a bottom, a first side wall, and an opposing second side wall. The battery module housing is an enclosure that protects the stack from mechanical damage and environmental exposure while providing a structure for integrating thermal management components. The battery module housing design is able to hold a liquid coolant, allowing the stack to be immersed in the liquid coolant for efficient thermal regulation. This immersion-based cooling mechanism or configuration enhances heat dissipation by ensuring uniform temperature distribution across the stack.

The spacers are configured to allow the liquid coolant to pass therethrough from one side of the stack to the other. The configuration of the spacers includes channels or openings that permit fluid flow through the interstitial spaces between battery cells, which ensures direct contact between the liquid coolant and the battery cells, improving thermal conductivity and preventing the formation of localized hot spots. This design improves thermal management performance, which can increase the reliability and safety of the battery module.

The first side wall of the battery module housing has a first bulge having a first flow passage and extending over (or along) its entire length, and the second side wall has a second bulge having a second flow passage and extending over (or along) its entire length. A bulge refers to a structural protrusion or contour integrated into (e.g., integrally formed in) the side wall of the battery module housing to enhance its fluid-handling capacity. The first bulge and the second bulge may have the same contour. The contour may be a half-round elevation from the plane of the side wall. The first and second bulges provide an optimized flow path for the liquid coolant, reducing flow resistance and promoting uniform coolant distribution, which enhances cooling efficiency because the coolant is effectively guided across the stack with minimal pressure drops.

A coolant inlet is located at one end of the first bulge, and a coolant outlet is located at one end of the second bulge. The coolant inlet and the coolant outlet are disposed diagonally opposite each other. This arrangement ensures a cross-flow pattern (or cross-flow path) for the liquid coolant, allowing it to traverse the stack diagonally. This diagonal flow path promotes uniform cooling by ensuring consistent heat removal throughout the stack, thereby minimizing thermal gradients. This arrangement improves energy efficiency of the thermal management system because it enables effective heat removal with minimal coolant usage and pump power or size requirements.

The battery module housing may have a top opening, which is covered by a cover tub. The top opening refers to an aperture or opening at the upper side of the battery module housing, and a cover tub is a detachable or fixed structure that seals the battery module housing but maintains terminals of the battery cells free (e.g., that exposes terminals of the battery cells) for establishing the electrical interconnection of the battery module. This configuration facilitates assembly, maintenance, and inspection of the internal components of the battery module while ensuring containment of the liquid coolant. The arrangement improves ease of manufacturing and serviceability, which can reduce downtime and enhance the module's operational lifespan.

A seal may be arranged between the battery module housing and the cover tub. A seal may be a component made of a deformable material, such as rubber or silicone, that prevents leakage of liquid or gas by forming a tight interface between two surfaces. This arrangement ensures that the coolant remains securely contained within the battery module housing, even during vibration or thermal expansion. This feature enhances reliability of the battery module because it reduces or minimizes the risk of coolant leakage and potential damage to the battery cells.

According to an embodiment, the spacers include cooling channels extending horizontally from one side of the stack to the other side of the stack. Cooling channels refer to passages integrated into the spacers that allow the liquid coolant to traverse laterally through the stack. This arrangement facilitates direct contact of the liquid coolant with the battery cells, enhancing heat removal efficiency. This feature improves the thermal regulation of the battery cells, resulting in increased operational safety and performance. According to one embodiment, the spacer has the shape of a corrugated sheet. The corrugated profile is aligned in the stack such that the liquid coolant can run along the corrugations from one side of the stack to the other.

According to an embodiment, a depth of the first bulge and a depth of the second bulge are the same. Depth may be understood as the horizontal distance in which a bulge protrudes from the side wall of the battery module housing. This symmetry in depth ensures uniform flow dynamics and eliminates discrepancies in pressure distribution across the coolant pathway. This arrangement enhances balance of coolant flow, which promotes even heat dissipation and avoids localized overheating.

According to an embodiment, in the battery module, the first bulge in the first side wall has a height h1, measured from the bottom of the battery module housing, that is less than a height h2 of the second bulge in the second side wall. A height may be understood as the vertical distance measured perpendicular to the bottom of the battery module housing, and a bulge refers to the protruding contour of a side wall. The measurement is taken at where the bulge protrudes the furthest from the horizontal plane of the side wall. This configuration ensures that the coolant flow path transitions smoothly from the first bulge to the second bulge, facilitating efficient diagonal and vertical fluid flow. This arrangement improves coolant distribution because the design reduces or minimizes turbulence and optimizes the flow direction, leading to consistent cooling across the stack.

According to another embodiment, a battery pack includes a side-by-side arrangement of two or more of the aforementioned battery modules, with the battery modules arranged such that the first side walls and second side walls are adjacent to one another. The first bulge in the first side wall has the height h1 that is less than the height h2 of the second bulge. The bulges of neighboring battery modules are not at the same height, but interlock in the side-by-side arrangement so that the installation space in the battery pack is optimally utilized. Accordingly, the height h1 and height h2 are selected (or determined) such that the first and second bulges of neighboring battery module housings are not next to each other (e.g., do not conflict with each other) but are horizontally below each other in the side-by-side arrangement. A side-by-side arrangement refers to the parallel positioning of multiple battery modules within a single battery pack housing. According to an embodiment, the depth of the first bulge and a depth of the second bulge are the same. Further, the contour of the first bulge and the contour of the second bulge may equal each other. This configuration allows for compact integration of multiple energy storage units while maintaining effective cooling. This arrangement increases energy density of the battery pack without compromising the thermal management system's performance.

According to another aspect of the disclosure, each of the aforementioned battery module, or battery pack, is incorporated into an electric vehicle. An electric vehicle may be understood as a transport vehicle powered primarily, alternatively, or in parallel by an electric motor and including energy stored in rechargeable batteries. The integration of the battery module (or the battery pack) into an electric vehicle provides a compact, efficient, and thermally managed energy source for vehicle propulsion. This arrangement contributes to sustainable mobility through the use of advanced, efficient energy storage technology.

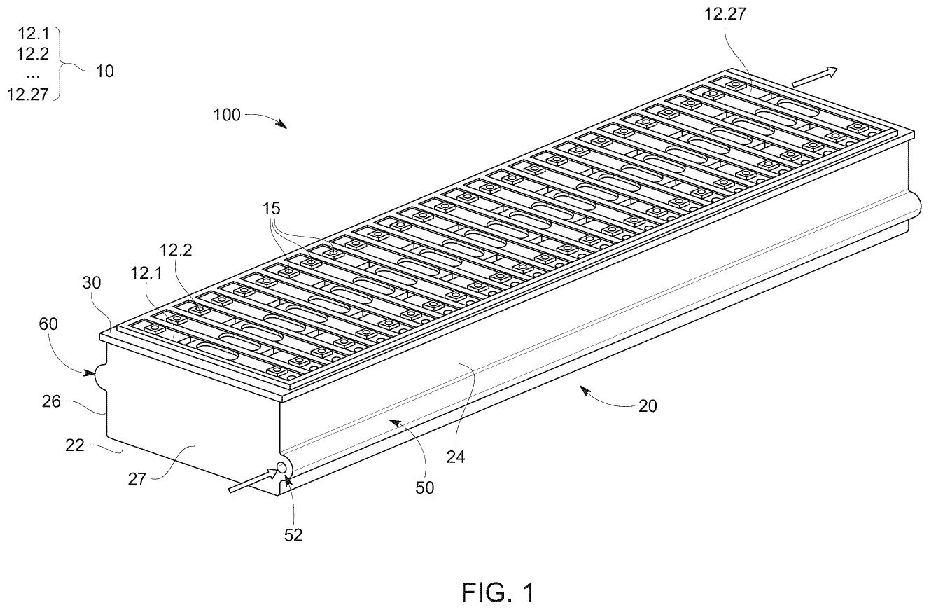

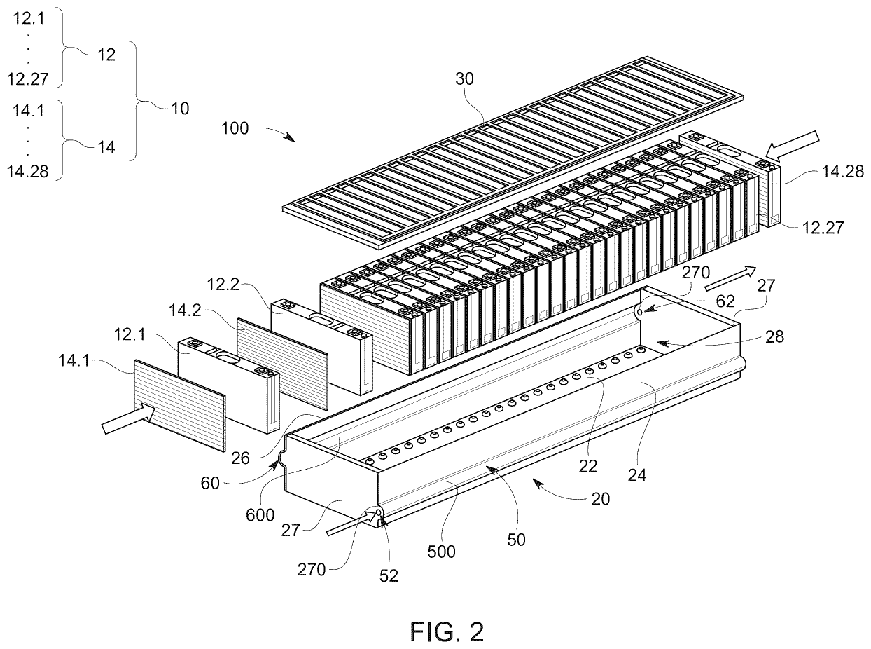

FIG. 1 is a perspective view of a battery module 100 according to an embodiment. FIG. 2 is an exploded view of the battery module 100 shown in FIG. 1. The battery module 100 includes a stack 10 of, in total, twenty-seven prismatic battery cells 12 (12.1-12.27) with spacers 14 (14.1-14.28) arranged between them (e.g., arranged between adjacent ones of the battery cells 12). The battery module 100 further includes a battery module housing 20 for accommodating the stack 10. The battery module housing 20 includes a bottom 22, a first side wall 24, an opposing second side wall 26, and a pair of narrow side walls 27 facing the ends of the stack 10. The battery module housing 20 may be formed of a metallic material, such as stainless steel or aluminum.

The battery module housing 20 has a top opening 28, which is covered by a cover tub 30. The cover tub 30 is a detachable (e.g., removable) or fixed structure that seals the battery module housing 20 but maintains (or exposes) terminals 15 of the battery cells 12 free for establishing the electrical interconnection of the battery module 100.

The battery module housing 20 is configured to hold a liquid coolant such that the stack 10 is immersed in the liquid coolant. Furthermore, the spacers 14 are configured to allow the liquid coolant to pass through from one side of the stack 10 to the other. The first side wall 24 includes a first bulge 50 extending over (or extending along) the entire length of the first side wall 24. The first bulge 50 has a first flow passage 500 for the liquid coolant. In the illustrated embodiment, the first flow passage 500 has a groove disposed on the inner surface of the first side wall 24 along the longitudinal direction of the first bulge 50. The second side wall 26 includes a second bulge 60 extending over (or extending along) the entire length of the second side wall 26. The second bulge 60 has a second flow passage 600 for the liquid coolant. In the illustrated embodiment, the second flow passage 600 has a groove disposed on the inner surface of the second side wall 26 along the longitudinal direction of the second bulge 60. In one embodiment, a depth of the first bulge 50 and a depth of the second bulge 60 are the same.

A coolant inlet 52 is provided at one end of the first bulge 50, and a coolant outlet 62 is provided at one end (e.g., at an opposite end) of the second bulge 60. In the illustrated embodiment, the coolant inlet 52 and the coolant outlet 62 are disposed diagonally opposite each other. In the illustrated embodiment, each of the pair of narrow side walls 27 includes protrusions 270 arranged opposite each other at both short side ends. The coolant inlet 52 has an opening provided in one of the protrusions 270 of the one narrow side wall 27, and the outlet 62 has an opening provided in one of the protrusions 270 of the other narrow side wall 27. In the illustrated embodiment, the first and second side walls 24, 26 and the narrow side walls 27 may form a structure for the battery module housing 20 by inserting the protrusions 270 of the narrow side walls 27 into the first flow passage 500 and the second flow passage 600. Further, the coolant inlet 52 is fluidly connected with the first flow passage 500, and the coolant outlet 62 is fluidly connected with the second flow passage 600. The liquid coolant enters the battery module housing 20 via the coolant inlet 52 and leaves the battery module housing 20 via the coolant outlet 62, which is illustrated by the arrows.

The stack 10 is composed of (e.g., includes) twenty-seven battery cells 12.1-12.27 and twenty-eight spacers 14.1-14.28 alternately arranged with the battery cells 12.1-12.27, which are compressed against each other prior to inserting the stack 10 into the battery module housing 20. The spacers 14.1-14.28 have the shape of a corrugated sheet.

FIG. 2 illustrates the inner shape of the second bulge 60 in the second side wall 26. The second bulge 60 is open on the inside so that the liquid coolant in the bulge area is in direct contact with the side walls of the battery cells 12.1-12.27. The first bulge 50 on the first side wall 24 has a similar contour.

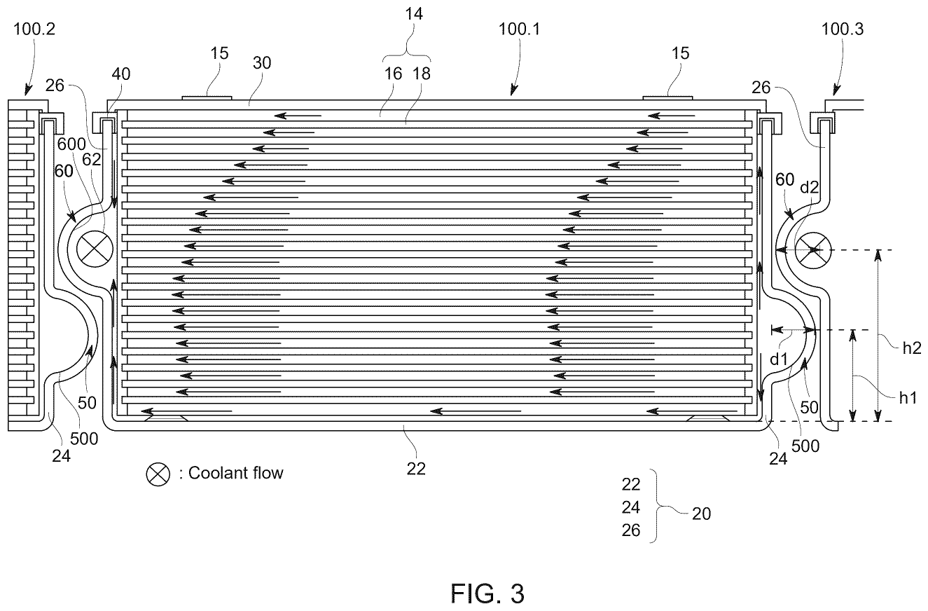

FIG. 3 is a partial cross-sectional view of a side-by-side arrangement of three battery modules 100.1-100.3 according to an embodiment and illustrates coolant flow through a spacer 14 of the battery module 100.1. The cross-section passes through the battery module housing 20 and the stack 10, parallel to one of the spacers 14 of the stack 10. The battery modules 100.1-100.3 may have the same structure as the battery module 100 illustrated in FIG. 1.

The spacer 14 includes cooling channels 16 and walls 18 horizontally connecting (or extending between) both sides of the stack 10 for passing the liquid coolant. As illustrated by the arrows, the liquid coolant passes from the first side wall 24 through the cooling channels 16 of the spacer 14 to the second side wall 26 and leaves the battery module housing 20 via the coolant outlet 62 positioned at one end of the second bulge 60.

A seal 40 is arranged between the battery module housing 20 and the cover tub 30. The cover tub 30 may include further seals to seal openings at where the terminals 15 of the battery cells 12.1-12.27 protrude therethrough.

The side-by-side arrangement illustrated in FIG. 3 includes three battery modules 100.1, 100.2, and 100.3. The first side wall 24 of the battery module housing 20 of the battery module 100.2 faces the second side wall 26 of the centrally positioned battery module 100.1. The first side wall 24 of the battery module housing 20 of the centrally positioned battery module 100.1 faces the second side wall 26 of the battery module 100.3.

The first bulge 50 on the first side wall 24 has a height h1, measured from the bottom 22 of the battery module housing 20, that is less than a height h2 of the second bulge 60 on the second side wall 26. The height h1 and height h2 are selected (e.g., may be selected or varied) such that the first bulges 50 and second bulges 60 of neighboring battery module housings 20 are not next to each other (e.g., do not conflict with each other) but are horizontally below each other in the side-by-side arrangement. Further, in the illustrated embodiment, a depth d1 of the first bulges 50 and a depth d2 of the second bulges 60 are the same in each of the battery modules 100.1-100.3. In addition, the first bulges 50 and the second bulges 60 have the same contour. Accordingly, a very compact arrangement of the battery modules 100.1-100.3 in a battery pack is achieved.

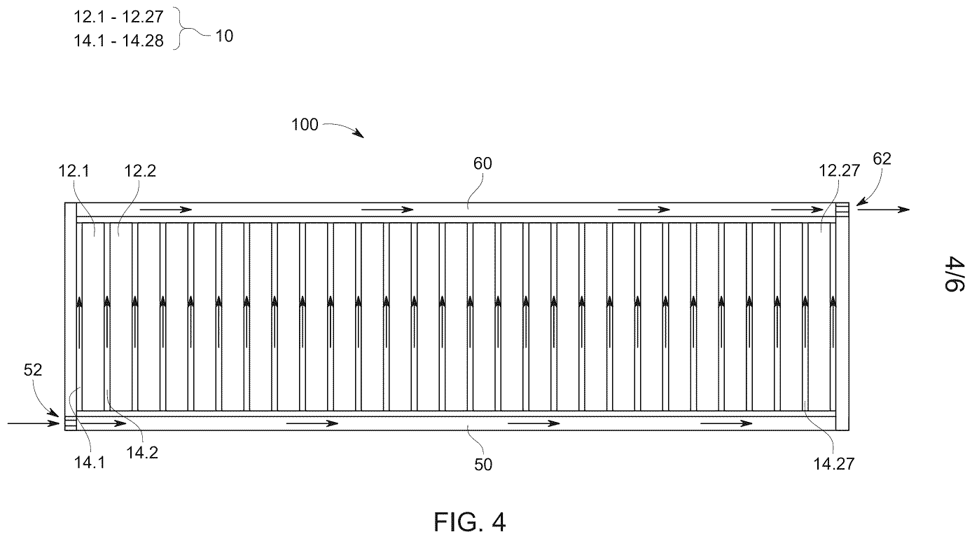

FIG. 4 is a top view on the battery module 100 shown in FIG. 1 without the cover tub 30 to illustrate the coolant flow within the battery module housing 20. The liquid coolant enters the battery module housing 20 at the coolant inlet 52. The liquid coolant is then distributed in lengthwise direction of the stack 10. A main coolant flow will pass the first bulge 50. Furthermore, the liquid coolant may also horizontally pass (e.g., pass through) the spacers 14.1-14.28 to be collected in the second bulge 60. Finally, the liquid coolant will leave the battery module housing 20 through the coolant outlet 62 provided at a diagonally opposite end of the second bulge 60 with respect to the coolant inlet 52.

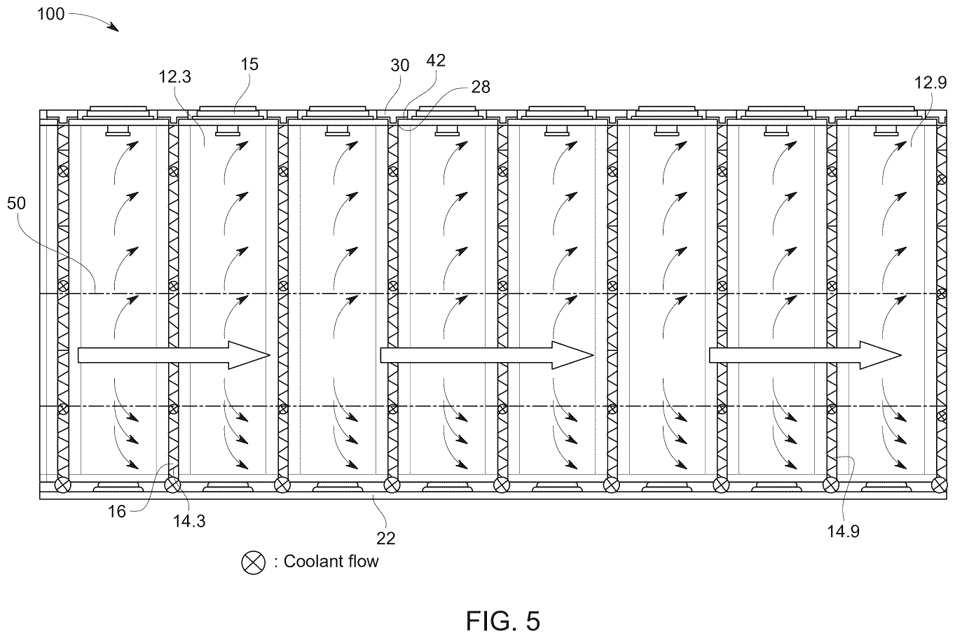

FIG. 5 is a partial cross-sectional view of the battery module shown in FIG. 1 and illustrates that coolant flow within a part of the battery module housing 20. The cut is made such that the first side wall 24 of the battery module housing 20 is omitted (or is not visible), allowing a view of a part of the stack 10. The cover tub 30 includes seals 42 to seal openings at where the terminals 15 of the batteries cells 12.1-12.27 protrude from the cover tub 30. The cover tub 30 is detachable and seals the battery module housing 20 to prevent the liquid coolant from leaking out of the top opening 28 in the battery module housing 20 but maintains the terminals 15 of the battery cells 12.1-12.27 free (e.g., exposed) for establishing the electrical interconnection of the battery module 100. As indicated by the arrows, the liquid coolant flows primarily along the first bulge 50 and also flows around the side walls of the battery cells 12.1-12.27 and enters (e.g., passes through) the cooling channels 16 of the spacers 14.1-14.28 to exit on the opposite side of the stack 10.

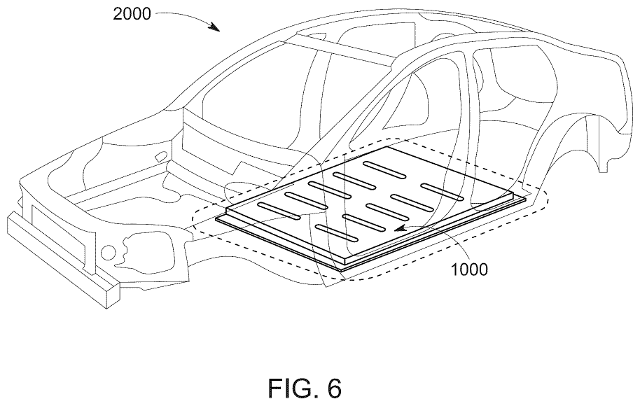

FIG. 6 schematically illustrates an electric vehicle 2000 including a battery pack 1000 according to another embodiment. The battery pack 1000 may include a single battery module 100, for example, the battery module 100 illustrated in FIG. 1, or multiple battery modules 100.1-100.3 arranged side-by-side, for example, as illustrated in FIG. 3.

### DESCRIPTION OF SOME REFERENCE NUMERALS

10 stack
12, 12.1-12.27 battery cell
14, 14.1-14.28 spacer
16 cooling channel
18 walls
20 battery module housing
22 bottom
24 first side wall
26 second side wall
27 narrow side wall
28 top opening
30 cover tub
40 seal
42 seal
50 first bulge
52 coolant inlet
60 second bulge
62 coolant outlet
100, 100.1-100.3 battery module
1000 battery pack
2000 electric vehicle

What is claimed is:

1. A battery module comprising:
a stack comprising a plurality of battery cells and spacers arranged between adjacent ones of the battery cells; and
a battery module housing accommodating the stack and comprising a bottom, a first side wall, and an opposing second side wall, the battery module housing being configured to hold a liquid coolant to immerse the stack in the liquid coolant, the spacers being configured to allow the liquid coolant to pass from one side of the stack to another side of the stack,
wherein the first side wall comprises a first bulge having a first flow passage for the liquid coolant, extending along the entire length of the first side wall, and having a coolant inlet at one end thereof, and
wherein the second side wall comprises a second bulge having a second flow passage for the liquid coolant, extending along the entire length of the second side wall, and having a coolant outlet at one end thereof.

2. The battery module as claimed in claim 1, wherein a depth of the first bulge and a depth of the second bulge are the same.

3. The battery module as claimed in claim 1, wherein the coolant inlet and the coolant outlet are diagonally opposite to each other.

4. The battery module as claimed in claim 1, wherein the battery module housing has a top opening that is covered by a cover tub.

5. The battery module as claimed in claim 4, wherein a seal is between the battery module housing and the cover tub.

6. The battery module as claimed in claim 1, wherein the spacers have cooling channels extending horizontally from one side of the stack to the other side of the stack.

7. The battery module as claimed in claim 6, wherein the spacers have the shape of a corrugated sheet.

8. The battery module as claimed in claim 1, wherein the first bulge on the first side wall has a height measured from the bottom of the battery module housing that is less than a height of the second bulge on the second side wall.

9. A battery pack comprising a side-by-side arrangement of a plurality of battery modules as claimed in claim 8, the battery modules being arranged such that the first side walls and the second side walls are adjacent to one another.

10. An electric vehicle comprising the battery pack as claimed in claim 9.

11. An electric vehicle comprising the battery module as claimed in claim 1.
